(19) United States
(12) Patent Application Publication
(10) Pub. No.: US 2025/0285420 A1
(43) Pub. Date: Sep. 11, 2025

(54) OBJECT DETECTION DEVICE, OBJECT DETECTION METHOD AND RECORDING MEDIUM

(71) Applicant: NEC Corporation, Tokyo (JP)

(72) Inventors: Yuki TANAKA, Tokyo (JP); Shuhei YOSHIDA, Tokyo (JP); Makoto TERAO, Tokyo (JP); Takashi SHIBATA, Tokyo (JP)

(73) Assignee: NEC Corporation, Tokyo (JP)

(21) Appl. No.: 19/049,193

(22) Filed: Feb. 10, 2025

(30) Foreign Application Priority Data
Mar. 6, 2024 (JP) 2024-034038

(51) Int. Cl. G06V 10/776; G06V 10/26; G06V 10/764; G06V 10/774

(52) U.S. Cl. CPC G06V 10/776; G06V 10/273; G06V 10/764; G06V 10/774

(57) ABSTRACT

In an object detection device, the object mask generation means outputs a mask indicating an area of an object included in an image and a detection score indicating detection accuracy of the area, based on the image and a prompt. The image clipping means outputs a clipped image obtained by clipping the area of the object from the image, based on the mask and the detection score. The object identification means identifies a category of the object based on the clipped image. The output means outputs the area of the object and the category of the object, as an object detection result.

### TECHNICAL FIELD

The present disclosure relates to object detection from images.

### BACKGROUND ART

An object detection technique using a machine learning model is known. Existing object detection methods generate an object detection model by using a large amount of images with ground truths as training data. Patent Document 1 discloses an object detection method using deep learning.

Patent Document 1: International Publication WO2024/013893

### SUMMARY

However, it takes cost and time to add ground truths to images used for training an object detection model.

It is an object of the present disclosure to provide an object detection method that can be constructed at a low cost and can perform object detection with high accuracy.

According to an example aspect of the present invention, there is provided an object detection device comprising:
an object mask generation means configured to output a mask indicating an area of an object included in an image and a detection score indicating detection accuracy of the area, based on the image and a prompt;
an image clipping means configured to output a clipped image obtained by clipping the area of the object from the image, based on the mask and the detection score;
an object identification means configured to identify a category of the object based on the clipped image; and
an output means configured to output the area of the object and the category of the object, as an object detection result.

According to another example aspect of the present invention, there is provided an object detection method executed by a computer, comprising:
outputting a mask indicating an area of an object included in an image and a detection score indicating detection accuracy of the area, based on the image and a prompt;
outputting a clipped image obtained by clipping the area of the object from the image, based on the mask and the detection score;
identifying a category of the object based on the clipped image; and
outputting the area of the object and the category of the object as an object detection result.

According to still another example aspect of the present invention, there is provided a non-transitory computer-readable recording medium storing a program, the program causing a computer to execute processing of:
outputting a mask indicating an area of an object included in an image and a detection score indicating detection accuracy of the area, based on the image and a prompt;
outputting a clipped image obtained by clipping the area of the object from the image, based on the mask and the detection score;
identifying a category of the object based on the clipped image; and
outputting the area of the object and the category of the object as an object detection result.

According to the present disclosure, it is possible to provide an object detection method capable of detecting objects at a low cost and with high accuracy.

### BRIEF DESCRIPTION OF THE DRAWINGS

FIG. 1 shows an overall configuration of an object detection device according to the present disclosure.

FIG. 2 is a block diagram showing a hardware configuration of the object detection device.

FIG. 3 is a block diagram showing a functional configuration of the object detection device.

FIGS. 4A to 4C show examples of a prompt.

FIG. 5 is a flowchart of an object detection processing.

FIG. 6 is a block diagram showing a configuration of a first application example of the object detection device.

FIG. 7 is a block diagram showing a configuration of a second application example of the object detection device.

FIG. 8 is a block diagram showing a functional configuration of another object detection device.

FIG. 9 is a flowchart of processing by the object detection device shown in FIG. 8.

### EXAMPLE EMBODIMENTS

Preferred example embodiments of the present disclosure will be described with reference to the accompanying drawings.

### First Example Embodiment

### [Overall Configuration]

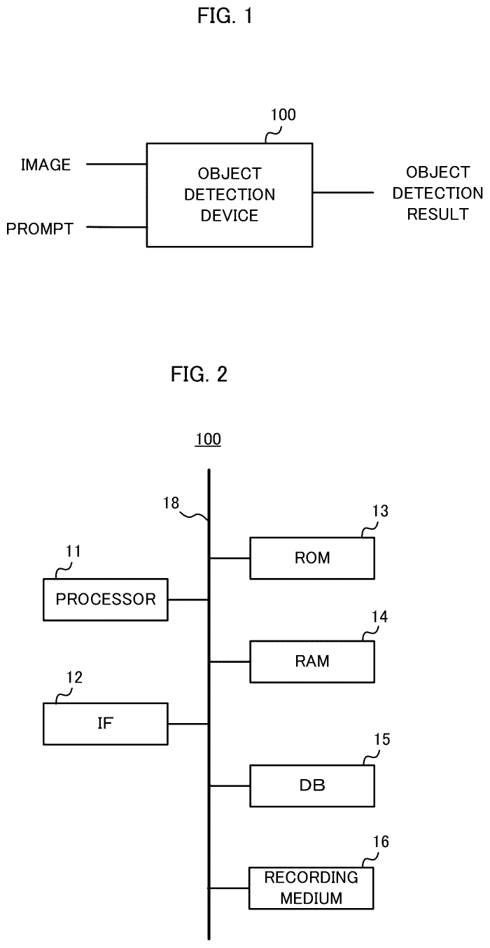

FIG. 1 shows an overall configuration of an object detection device according to the present disclosure. The object detection device 100 detects objects included in the images. Specifically, images and prompts are input to the object detection device 100. The prompts are AI (Artificial Intelligence) instructions or inputs that the user gives to the model. More information about these prompts will be provided later. The object detection device 100 detects an area of an object in the image on the basis of the input image and prompt, and outputs a category of the object included in the area, a score indicating likelihood of the object, or the like as an object detection result.

### [Hardware Configuration]

FIG. 2 is a block diagram showing a hardware configuration of the object detection device 100. As shown, the object detection device 100 includes a processor 11, an interface (IF) 12, a ROM (Read Only Memory) 13, a RAM (Random Access Memory) 14, a data base (DB) 15, and a recording medium 16. Each component is connected, for example, through a bus 18.

The processor 11 is a computer such as a CPU (Central Processing Unit) and controls the entire object detection device 100 by executing a program prepared in advance. Specifically, the processor 11 may be a CPU, a GPU (Graphics Processing Unit), a DSP (Digital Signal Processor), an MPU (Micro Processing Unit), an FPU (Floating Point number Processing Unit), a PPU (Physics Processing Unit), a TPU (Tensor Processing Unit), a quantum processor, a microcontroller, or a combination thereof.

The processor 11 loads the program stored in the ROM 13 or the recording medium 16 to the RAM 14 and executes the processes coded in the program. The processor 11 serves as a part or all of the object detection device 100. The processor 11 performs the object detection processing to be described later.

The IF 12 transmits and receives data to and from external devices. Specifically, the object detection device 100 receives images and prompts from a user through the IF 12, and outputs the object detection result to a display device or other external devices.

The ROM 13 stores various programs to be executed by the processor 11. The RAM 14 is used as a working memory during various processes performed by the processor 11.

The DB 15 stores various algorithms, data, machine-learning models, and the like that are used when the object detection device 100 executes the object detection processing described later. The DB 15 may also store images or prompts input by the user.

The recording medium 16 is a non-volatile and non-transitory storage medium such as a disk-like recording medium, a semiconductor memory, or the like. The recording medium 16 may be configured attachable to and detachable from the object detection device 100. The recording medium 16 records various programs executed by the processor 11.

In addition to the above, the object detection device 100 may include a display device such as a liquid crystal display, and an input device such as a keyboard or a mouse. These display devices and input devices are used, for example, by an operator of the object detection device 100.

### [Functional Configuration]

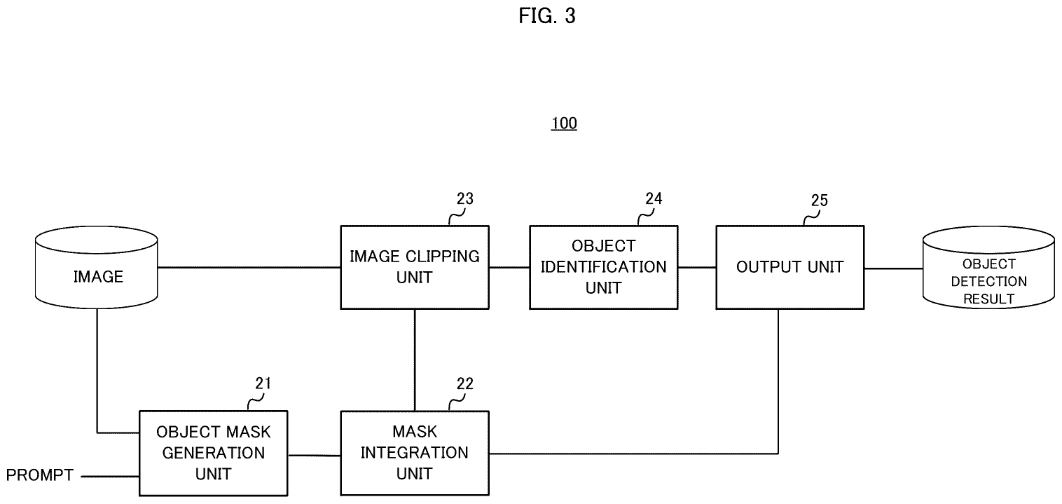

FIG. 3 is a block diagram showing a functional configuration of the object detection device 100. The object detection device 100 functionally includes an object mask generation unit 21, a mask integration unit 22, an image clipping unit 23, an object identification unit 24, and an output unit 25.

The image input by the user is supplied to the object mask generation unit 21 and the image clipping unit 23. The prompt input by the user is supplied to the 5 object mask generation unit 21.

The object mask generation unit 21 generates and outputs an object mask on the basis of the input image and the input prompt. The object mask is a mask that indicates the area of the object in the image. The object mask generation unit 21 has a function of segmenting the area specified by the prompt in the input image to generate a segmentation mask (hereinafter, also referred to simply as a “mask”). As the object mask generation unit 21, for example, SAM (Segment Anything Model) can be used as a segmentation model. However, the present invention is not limited thereto, and any model capable of generating a mask for each object in the image May be used.

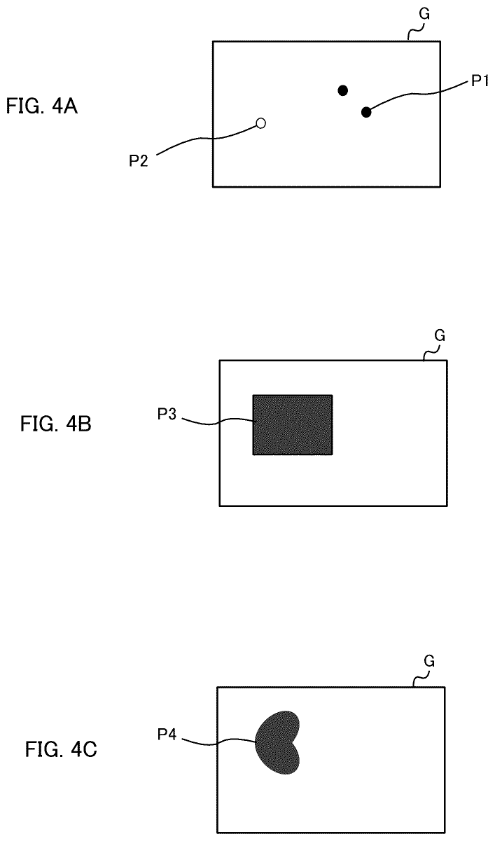

The prompt has a role of specifying the area to be segmented for the object mask generation unit 21. FIGS. 4A to C show examples of the prompt that is input to the object mask generation unit 21. As shown, the prompt is specified inside the image G.

FIG. 4A shows an example in which points are input as a prompt. For example, by specifying one or more point P1 as a positive prompt, the object mask generation unit 21 can output the mask of the area of the object including the point P1. On the other hand, by specifying one or more point P2 as a negative prompt, the object mask generation unit 21 can output a mask of an area of an object that does not include the point P2.

FIG. 4B shows an example in which a rectangle (box) is input as a prompt. For example, by specifying one rectangle P3 as a prompt, the object mask generation unit 21 can output a mask of the area of the object included in the rectangle P3.

FIG. 4C shows an example in which an arbitrary shape area is input as a prompt. For example, by specifying an arbitrary shape area P4 as a prompt, the object mask generation unit 21 can output a mask of an area of an object included in the area P4

For one image, one prompt may be input, or multiple prompts may be input. If more than one prompt is input for one image, the area of the object extracted based on each prompt is output as a mask. Therefore, the object mask generation unit 21 may output a plurality of masks on the basis of a plurality of prompts for one object in the image.

Usually, since it is not known which position in the image an object exists, it is preferable that the prompts input to the object mask generation unit 21 cover the entire image. For example, as the prompts to be input, a plurality of points may be arranged in a lattice shape or randomly on the entire image. Further, as the prompts to be input, a plurality of rectangles may be arranged regularly on the entire image or a plurality of rectangles may be arranged at random.

In the image subjected to the object detection, if it is known that an object exists in a specific area in the image with high possibility, a prompt specifying the area may be input. For example, if it is known that people appear in the upper right area of the video of the surveillance camera set at a certain location, a prompt to specify the upper right area of the image may be generated and input.

The object mask generation unit 21 generates a score (hereinafter, also referred to as “detection score”) indicating the detection accuracy of the area, i.e., the degree of likelihood as an object, for each of the generated masks. The object mask generation unit 21 outputs the generated mask and the score to the mask integration unit 22.

The mask integration unit 22 integrates a plurality of masks generated by the object mask generation unit 21. As described above, a plurality of masks may be generated for one object in the image. The mask integration unit 22 integrates the plurality of masks generated for the same object into one or more masks (hereinafter, referred to as “integrated masks”) on the basis of the overlap degree and the detection score. Techniques for integrating a plurality of masks include, for example, NMS (Non-Maximum Suppression) and soft-NMS, but are not limited to them if it is possible to integrate a plurality of masks with some criteria. The mask integration unit 22 outputs the integrated masks to the image clipping unit 23 and the output unit 25.

The image clipping unit 23 cuts out the area indicated by the integrated mask from the input image to generate an image (hereinafter, referred to as “clipped image”). If the input integrated masks are multiple, the image clipping unit 23 generates multiple clipped images from one image and outputs them to the object identification unit 24.

There are several methods for clipping an image by the image clipping unit 23. In the first method, the image clipping unit 23 clips the image along the input integrated mask. Thus, the contour of the clipped image coincides with the contour of the integrated mask. In the second method, the image clipping unit 23 clips the image along the smallest rectangle (box) surrounding the integrated mask. Thus, the clipped image becomes a rectangular image including an area of the integrated mask.

In the third method, the image clipping unit 23 clips the image by giving a margin to the integrated mask. For example, the image clipping unit 23 clips the image with a shape obtained by adding a margin of a predetermined number of pixels to the outer periphery of the integrated mask. Alternatively, the image clipping unit 23 may clip an image in a shape obtained by enlarging the integrated mask at a predetermined magnification. In the third method, it becomes possible to include the information around the integrated mask in the image into the clipped image, and the improvement in the accuracy in the object identification in the subsequent stage can be expected.

The object identification unit 24 identifies the category of the object indicated by the input clipped image and outputs the category together with a score (hereinafter, also referred to as “identification score”) indicating the likelihood. As the object identification unit 24, a trained object identification model may be used, or a newly generated object identification model for identification of the clipped image may be used. In this case, data on Web, public data, data collected for training, and the like can be used as the training data for generating the object identification model.

As described above, the clipped images input from the image clipping unit 23 is present by the number of integrated masks. Therefore, the object identification unit 24 outputs the category and the identification score of the object for each clipped image. In the above description, the input to the object identification unit 24 is the clipped image. Instead, the input to the object identification unit 24 may be a feature value of the clipped image. Specifically, in one method, the feature value is extracted from the clipped image, and the extracted feature value may be input to the object identification unit 24. In another method, the image clipping unit 23 may calculates the feature value of the entire original image before clipping the image, extracts the feature value corresponding to the area clipped by the image clipping unit 23 from the feature value of the entire image, and then input the extracted feature value to the object identification unit 24.

The output unit 25 outputs the object detection result based on the category and the identification score of the object input from the object identification unit 24 and the integrated mask input from the mask integration unit 22. For example, the object identification unit 24 may output, for each object included in the image, a plurality of categories and identification scores for the plurality of categories, as an object detection result. Alternatively, the object identification unit 24 may output, as the object detection result, a category having the highest identification score or a predetermined number of categories having the higher identification score for each object included in the image. In this case, the output unit 25 may output only the category of the object and not output the identification score. The output unit 25 outputs, as an object detection result, an image in which an area of the integrated mask is superimposed and displayed on the original image.

### [Object Detection Processing]

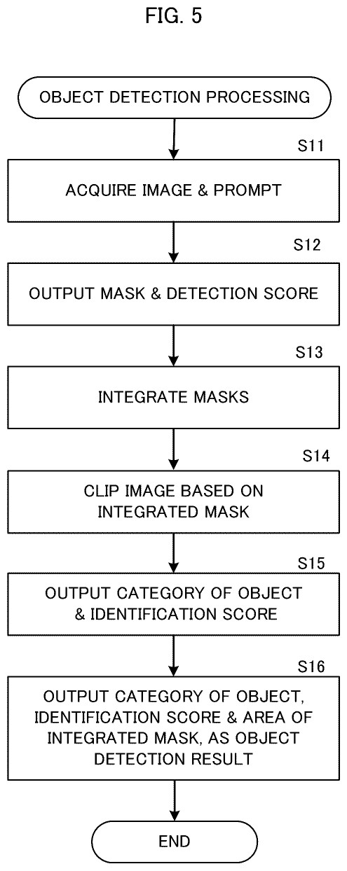

Next, a flow of object detection processing by the object detection device 100 will be described. FIG. 5 is a flowchart of the object detection processing. This processing is realized by the processor 11 shown in FIG. 2, which executes a pre-prepared program and operates as the elements shown in FIG. 3.

First, the object detection device 100 acquires an input image and an input prompt (step S11). Next, the object mask generation unit 21 outputs the mask indicating the area of the object and the detected score on the basis of the input image and the input prompt (step S12). Next, the mask integration unit 22 integrates a plurality of masks that are considered to correspond to the same object to generate an integrated mask (step S13).

Next, the image clipping unit 23 generates a clipped image from the input image, based on the integrated mask (step S14). Next, the object identification unit 24 identifies an object based on the clipped image, and outputs the category of the object and the identification score (step S15). Next, the output unit 25 outputs the category of the object, the identification score, and the image in which the area of the integrated mask is superimposed, as the object detection result (step S16). Then, the object detection processing ends.

As described above, the object detection device 100 of this example embodiment generates the mask indicating the area of the object based on the image and the prompt, and detects the object by cutting out the area of the mask from the image to identify the object. Therefore, it is possible to use a base model such as SAM in which training is not necessary for generating a mask indicating an area of an object, and it is possible to make it unnecessary to train a model for generating a mask.

### [Application Example]

Next, an application example of the object detection device 100 will be described.

### First Application Example

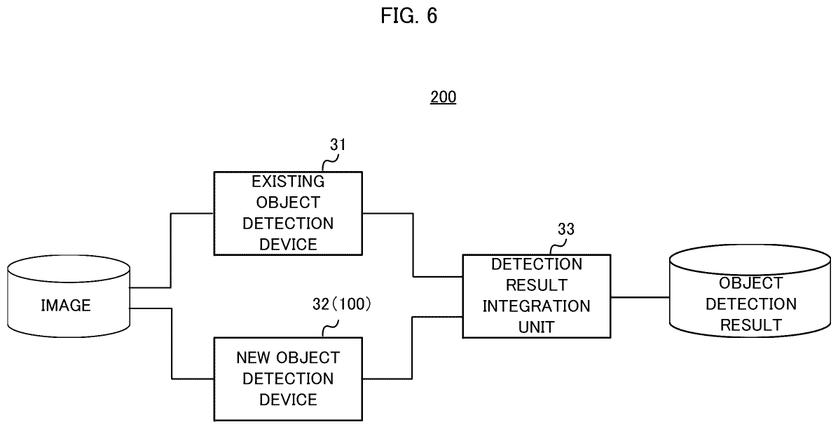

FIG. 6 is a block diagram showing a configuration of a first application example of the object detection device of the present example embodiment. In the first application example, the object detection device 100 of the present example embodiment is used together with an existing object detection device. As illustrated, the object detection system 200 of the first application example includes an existing object detection device 31, a new object detection device 32, and a detection result integration unit 33.

An image serving as a target of object detection is input to the existing object detection device 31 and the new object detection device 32. Here, the existing object detection device 31 is, for example, an object detection device using an existing object detection model such as a CNN (Convolutional Neural Network)-based Faster R-CNN or a Transformer-based DETR. In contrast, the new object detection device 32 corresponds to the object detection device 100 of this example embodiment. Therefore, although not shown in FIG. 6, a prompt is input to the new object detection device 32 in addition to the image.

The existing object detection device 31 detects an object from the image using the existing object detection model described above, and outputs the position, size, category, score, and the like of the object as the object detection result to the detection result integration unit 33. On the other hand, the new object detection device 32 detects an object from the image by the method of the object detection device 100 of the present example embodiment described above, and outputs the position, size, category, score, and the like of the object as the object detection result to the detection result integration unit 33. The detection result integration unit 33 integrates the object detection result of the existing object detection device 31 with the object detection result of the new object detection device 32, and outputs the integrated detection result. For example, the detection result integration unit 33 integrates the object detection result output by the existing object detection device 31 and the new object detection device 32 by a technique such as NMS, and outputs the integrated detection result.

The first application example is suitable in the case where a new category is added to the existing object detection device 31, for example. Usually, when a new category is added to the object detection device, it is necessary to collect images of the new category and giving ground truths to them to prepare a large amount of training data, which results in high cost. In this regard, according to the first application example, the objects in the existing categories can be detected with high accuracy by the existing object detection device 31, and the object of the new category can be detected with high accuracy by the new object detection device 32. Therefore, by integrating the detection results and outputting the integrated detection result, it becomes possible to cope with new categories at low cost.

### Second Application Example

The second application example basically comprises the same configuration as the first application example. However, the second application example is different from the first application example in that the integrated detection results generated by the detection result integration unit 33 is used for the retraining of the existing object detection device 31.

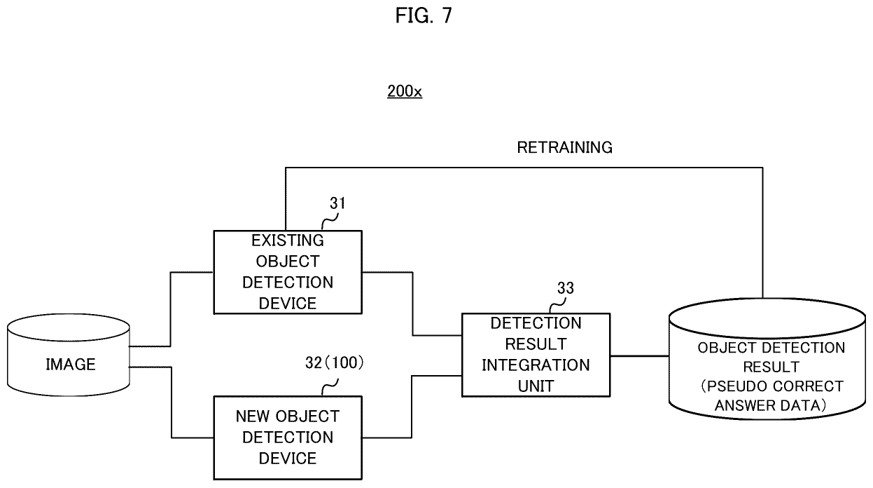

FIG. 7 is a block diagram showing a configuration of the second application example of the object detection device of the present example embodiment. The object detection system 200x of the second application example performs retraining of the existing object detection device 31 using the integrated detection results generated by the detection result integration unit 33 as pseudo ground truth data. Thus, when adding a new category, it is not necessary to manually add the ground truths to the training data, so that the existing object detection device 31 can be adapted to the new category at a low cost.

### [Use Case]

The object detection device described above can be utilized for object detection in general. As an example, the above-described object detection device can be utilized for detecting goods disposed in a store or detecting articles housed in a warehouse, or the like. In this case, based on the detection result, it is possible to perform inventory management of stores and warehouses. As another example, the above-described object detection device may be utilized for controlling objects. For example, the control device may detect objects using the object detection technique described above, determine the operation of the objects such as an automobile or a robot based on the detection result, and control those objects according to the determined operation.

### Second Example Embodiment

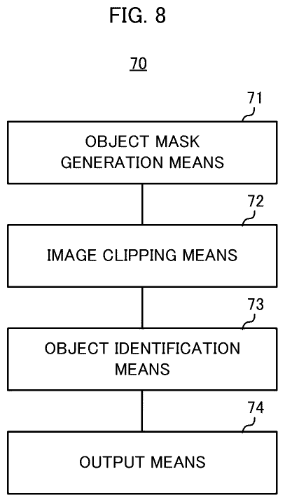

FIG. 8 is a block diagram showing a functional configuration of an object detection device of the second example embodiment. The object detection device 70 includes an object mask generation means 71, an image clipping means 72, an object identification means 73 and an output means 74.

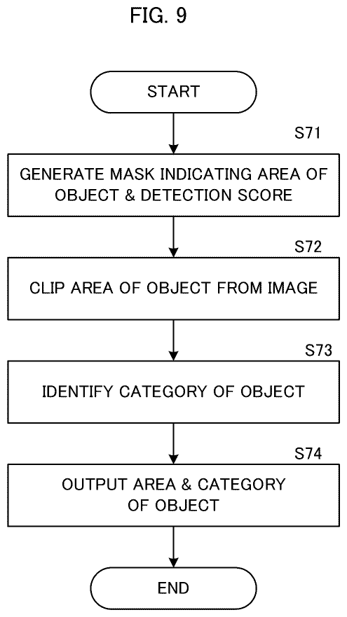

FIG. 9 is a flowchart of processing executed by the object detection device of the second example embodiment. The object mask generation means 71 outputs a mask indicating an area of an object included in an image and a detection score indicating detection accuracy of the area, based on the image and a prompt (step S71). The image clipping means 72 outputs a clipped image obtained by clipping the area of the object from the image, based on the mask and the detection score (step S72). The object identification means 73 identifies a category of the object based on the clipped image (step S73). The output means 74 outputs the area of the object and the category of the object, as an object detection result (step S74).

According to the object detection device 70 of the second example embodiment, it is possible to detect objects at low cost and with high accuracy.

A part or all of the example embodiments described above may also be described as the following supplementary notes, but not limited thereto.

### Supplementary Note 1

An object detection device comprising:
an object mask generation means configured to output a mask indicating an area of an object included in an image and a detection score indicating detection accuracy of the area, based on the image and a prompt;
an image clipping means configured to output a clipped image obtained by clipping the area of the object from the image, based on the mask and the detection score;
an object identification means configured to identify a category of the object based on the clipped image; and
an output means configured to output the area of the object and the category of the object, as an object detection result.

### Supplementary Note 2

The object detection device according to Supplementary note 1, further comprising a mask integration means configured to integrate a plurality of masks corresponding to a same object to generate an integrated mask, based on the mask and the detection score,
wherein the image clipping means clips the area of the object using the integrated mask.

### Supplementary Note 3

The object detection device according to Supplementary note 2, wherein the image clipping means clips the image along a shape of the integrated mask.

### Supplementary Note 4

The object detection device according to Supplementary note 2, wherein the image clipping means clips the image along a rectangle surrounding the integrated mask.

### Supplementary Note 5

The object detection device according to Supplementary note 2, wherein the image clipping means clips the image along a shape larger than the integrated mask.

### Supplementary Note 6

The object detection device according to Supplementary note 1,
wherein the object identification means outputs an identification score indicating identification accuracy of the category of the object, and
wherein the output means further outputs the identification score as the object detection result.

### Supplementary Note 7

An object detection system comprising:
the object detection device according to Supplementary note 1;
another object detection device different from the object detection device; and
a detection result integration means configured to integrate a first object detection result output by the object detection device and a second object detection result output by the another object detection device to output a third object detection result.

### Supplementary Note 1

An object detection system comprising:
the object detection device according to Supplementary note 1;
another object detection device different from the object detection device;
a detection result integration means configured to integrate a first object detection result output by the object detection device and a second object detection result output by the another object detection device to output a third object detection result; and
a training means configured to train the another object detection device using the third object detection result as training data.

### Supplementary Note 9

An object detection method comprising:
outputting a mask indicating an area of an object included in an image and a detection score indicating detection accuracy of the area, based on the image and a prompt;
outputting a clipped image obtained by clipping the area of the object from the image, based on the mask and the detection score;
identifying a category of the object based on the clipped image; and
outputting the area of the object and the category of the object as an object detection result.

### Supplementary Note 10

A non-transitory computer-readable recording medium storing a program, the program causing a computer to execute processing of:
outputting a mask indicating an area of an object included in an image and a detection score indicating detection accuracy of the area, based on the image and a prompt;
outputting a clipped image obtained by clipping the area of the object from the image, based on the mask and the detection score;
identifying a category of the object based on the clipped image; and
outputting the area of the object and the category of the object as an object detection result.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

This application is based upon and claims the benefit of priority from Japanese Patent Application 2024-34038, filed on Mar. 6, 2024, the disclosure of which is incorporated herein in its entirety by reference.

### DESCRIPTION OF SYMBOLS

11 Processor
21 Object mask generation unit
22 Mask integration unit
23 Image clipping unit
24 Object identification unit
25 Output unit
31 Existing object detection device
32 New object detection device
33 Detection result integration unit
100 Object detection device
200, 200x object detection system

1. An object detection device comprising:
a memory configured to store instructions; and
a processor configured to execute the instructions to:
output a mask indicating an area of an object included in an image and a detection score indicating detection accuracy of the area, based on the image and a prompt;
output a clipped image obtained by clipping the area of the object from the image, based on the mask and the detection score;
identify a category of the object based on the clipped image; and
output the area of the object and the category of the object, as an object detection result.

2. The object detection device according to claim 1,
wherein the processor is further configured to integrate a plurality of masks corresponding to a same object to generate an integrated mask, based on the mask and the detection score, and
wherein the processor clips the area of the object using the integrated mask.

3. The object detection device according to claim 2, wherein the processor clips the image along a shape of the integrated mask.

4. The object detection device according to claim 2, wherein the processor clips the image along a rectangle surrounding the integrated mask.

5. The object detection device according to claim 2, wherein the processor clips the image along a shape larger than the integrated mask.

6. The object detection device according to claim 1,
wherein the processor outputs an identification score indicating identification accuracy of the category of the object, and
wherein the processor further outputs the identification score as the object detection result.

7. An object detection system comprising:
the object detection device according to claim 1; and
another object detection device different from the object detection device,
wherein the processor is further configured to integrate a first object detection result output by the object detection device and a second object detection result output by the another object detection device to output a third object detection result.

8. An object detection system comprising:
the object detection device according to claim 1; and
another object detection device different from the object detection device,
wherein the processor is further configured to execute the instructions to:
integrate a first object detection result output by the object detection device and a second object detection result output by the another object detection device to output a third object detection result; and
train the another object detection device using the third object detection result as training data.

9. An object detection method comprising:
outputting a mask indicating an area of an object included in an image and a detection score indicating detection accuracy of the area, based on the image and a prompt;
outputting a clipped image obtained by clipping the area of the object from the image, based on the mask and the detection score;
identifying a category of the object based on the clipped image; and
outputting the area of the object and the category of the object as an object

10. A non-transitory computer-readable recording medium storing a program, the program causing a computer to execute processing of:
outputting a mask indicating an area of an object included in an image and a detection score indicating detection accuracy of the area, based on the image and a prompt;
outputting a clipped image obtained by clipping the area of the object from the image, based on the mask and the detection score;
identifying a category of the object based on the clipped image; and
outputting the area of the object and the category of the object as an object detection result.
